(19) United States
(12) Patent Application Publication
(10) Pub. No.: US 2005/0182157 A1
(43) Pub. Date: Aug. 18, 2005

(54) Polymer composite and method of making

(76) Inventor: Csaba Truckai, Saratoga, CA (US)

Correspondence Address: Csaba Truckai, 19566 Arden Court, Saratoga, CA, 95070, US

(21) Appl. No.: 10/779,075

(22) Filed: Feb. 14, 2004

(51) Int. Cl. C08K 9/00; C08K 3/40

(52) U.S. Cl. 523/217; 521/50; 524/494

(57) ABSTRACT

A thermally insulated polymeric composition, and more particularly, to a thermoplastic polymer with an embedded filler component that comprises a volume of particles, shells, filaments or the like that exhibit low thermal conductivity properties. In one embodiment, the filler can consist of hollow glass microspheres that have a thermal conductivity of less than 5 W/m-° K. In one embodiment, the polymeric composition carries thermochromic materials for that allow visual checks of an object surface for defects in a polymeric coating.

### BACKGROUND OF THE INVENTION

1. Field of the Invention

This invention relates to polymer composite materials, and more particularly, relates to a thermoplastic polymer with an embedded filler component that comprises a volume of hollow glass or ceramic microspheres that exhibit extremely low thermal conductivity properties measured in W/m-° K.

2. Description of the Related Art

In many fields, there are increasing market needs for high performance insulating materials. Industrial processes require insulated coatings for tubing or pipe that can range in size from the micron scale to the multi-meter scale. In macroscale applications, for example, oil transfer pipelines in arctic climates often require an insulated coating. In microscale applications, the electronics industry has many applications for insulated tubing. One example is in the field of microprocessor cooling. The trend toward faster and more sophisticated integrated circuits has resulted in microprocessors and power supplies that generate considerable heat during operation. Technologies and strategies are being developed that replace heat sinks. In many microprocessor cooling technologies, fluid circulation is used to carry cooling fluids to a remote site-which will benefit from microscale insulated tubing.

In military and consumer applications, highly insulative plastics material would be useful for pharmaceutical and medical supply packaging, food packaging, and disposable and reusable containers for general uses. Medical thermotherapy and cryotherapy devices would benefit from insulative plastics, for example in probes, catheters, heat pads and the like.

In aircraft and automobile industries, insulated plastics would be useful for interior panels. In many industries, there is an additional need for plastics that are not only thermal insulators but are also flame resistant.

### SUMMARY OF THE INVENTION

The present invention discloses a new class of polymeric compositions that have extraordinary thermal insulation properties. More particularly, an exemplary polymer composition comprises a thermoplastic polymer with an embedded filler component that comprises a volume of particles, shells, filaments or the like that exhibit very low thermal conductivity properties. In one embodiment, the filler can consist of hollow glass microspheres that have a thermal conductivity of less than 5 W/m-° K. More preferably, the microspheres that have a thermal conductivity of less than 2 W/m-° K., and still more microspheres that have a thermal conductivity of less than 0.5 W/m-° K.

The present invention provides new polymeric thermal insulator materials for industrial, military and consumer uses.

In general, the polymeric composition of the invention advantageously provides a base polymer with insulative microspheres, microparticles, nanoparticles or filaments dispersed therein.

The polymeric composition provides an insulator with ultra-low conductivity hollow glass or ceramic particles.

Other advantages and objective of the invention are described below in the specification and the accompanying drawings.

### BRIEF DESCRIPTION OF THE DRAWINGS

The accompanying drawings are included to provide a further understanding of the invention and are incorporated in and constitute a part of this disclosure. The embodiments in the drawings taken together with the description serve to explain the principles of the present invention.

FIG. 1 is a schematic view of a polymer insulator material in the form of a sleeve.

FIG. 2 is an enlarged sectional view of a portion of the polymer insulator material of FIG. 1.

FIG. 3 is an enlarged sectional view of an alternative polymer insulator material with a flame retardant surface.

FIG. 4 is a sectional view of an alternative polymer with a surface thermochromic layer.

FIG. 5 is an enlarged sectional view of an alternative polymer with an insulator material having a metallic coating.

### DESCRIPTION OF THE PREFERRED EMBODIMENTS

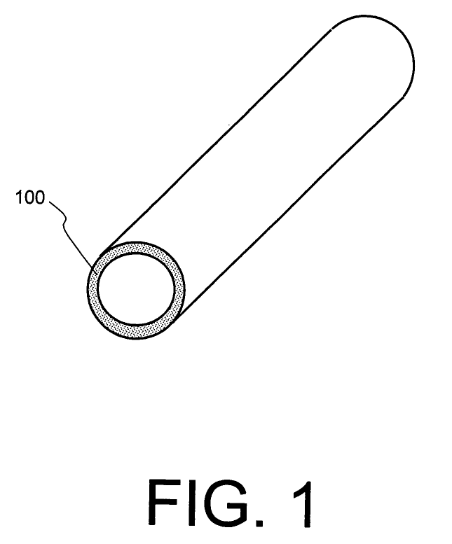

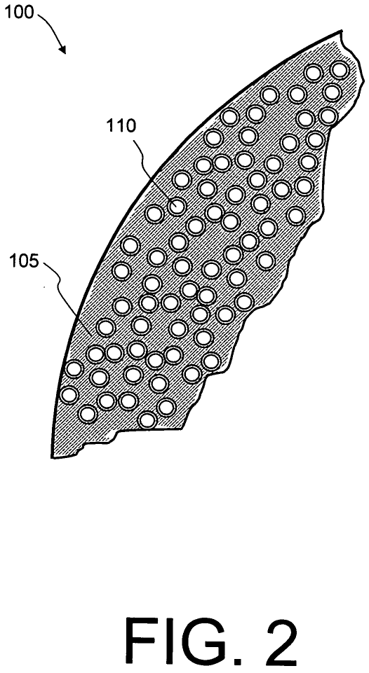

This invention relates to a class of polymeric compositions that provide extraordinary thermal insulation properties. Referring to FIG. 1, an exemplary object, a tube, is shown that is fabricated of a polymer insulator composition 100 corresponding to the invention. As can be seen in FIG. 2, the base polymer 105 carries a filler material 110 that consists of thermally insulative microspheres or other filler having similar insulative properties. The base polymer 105 can be a crystalline or semi-crystalline polymer such as a polyolefin and more particularly a polyethylene. The polymer 105 also can be a polyamide, a polycarbonate, a polystyrene, a polyacrylonitrile, a polyethylene oxide, a polyacetal, a thermoplastic modified cellulose, a polysulfone, a thermoplastic polyester such as PET, poly(ethyl acrylate), or poly(methyl methacrylate), a nylon, a fluoropolymer such as polyvinylidene fluoride, an ethylene tetrafluoroethylene, or blends of two or more of the above polymers. The polymers described above are well known and are available from Dow Chemical, Union Carbide or Dupont-Mitsui Polychemicals Co., Ltd., all of which manufacture one or more of the above polymers.

Referring to FIG. 2, one type of filler material 110 consists of micron-dimension or nanoscale microspheres that are fabricated of a glass. In one example, the filler material consists of Q-CEL® hollow microspheres that are manufactured by Potters Industries, Inc., 820 Lufkin Road Apex, N.C. 27502-0298. The hollow microspheres are selected to have very low thermal conductivity properties, wherein glass material can be the form of soda-lime glass or borosilicate. In another embodiment, the filler can be Pyrex or any ceramic in the form of hollow microspheres or particles. When in the form of particles, the material can be solid or porous, but hollow materials are preferred. The scope of the invention extends to filler materials that hollow, porous or solid elements in any microscale or nanoscale form, such as filaments, tubules, whiskers and the like that have thermal properties as described below.

In another embodiment filler material, the hollow micro- or nanospheres or tubes also can be provided with any selected gas within the hollow body. An inert gas (e.g., argon) would be useful in preventing or limiting oxidation in the composition during mixing and thereafter. The hollow micro- or nanospheres also can have a partial vacuum therein and can be compounded with the base polymer in a partial vacuum which can enhance the thermally non-conductive properties of the final polymer composition.

Thermal conductivity is a measure of the ability of a material of body to conduct heat, determined by the rate of heat flow normally through an area in the material divided by the area and by minus the component of the temperature gradient in the direction of flow, measured in W/m-° K. (watts per meter per degree Kelvin). In one embodiment, the filler material defines a thermal conductivity of less than about 5 W/m-° K. Preferably, the filler material 110 defines a thermal conductivity of less than about 2 W/m-° K. More preferably, the filler material 110 defines a thermal conductivity of less than about 0.5 W/m-° K.

The filler material preferably generally makes up more than about 5% by volume of the final polymeric composition 100 with the base polymer 105 making up the balance. The filler material can comprise as much as about 80% by volume of the final polymeric composition 100.

Other fillers can be included in the polymer composition 100, such as particles of magnesium or titanium, which are reductive and can assist in preventing oxidation within the polymer chains of the base polymer 105.

The filler materials are mixed into a melt-state base polymer until the particles are well dispersed. By any technique known in the art, the mixing is accomplished in a system that provides a temperature higher than the melting point of the polymeric base 105. In mixing the polymer base 105 with the filler materials 110, together with the optional additives described below, the objective of mixing is to create a uniform dispersal of the filler material.

In one method of fabricating the polymer composition 100, it has been found that an important step is providing an inert gas atmosphere (e.g., argon gas) in which the polymer (e.g., a high density polyethylene) is mixed at a selected temperature ranging between about 125° C. and 300° C. The protective gas atmosphere can substantially eliminate oxidation that otherwise would occur to some extent within the base polymer. A particular advantage is that the mixing or compounding step can be extended in duration—even to one or more hours of mixing—without oxidation and degradation of the composition.

The thermoplastic polymer base 105 can carry other additives known in the art, such as flame retardants or anti-arcing compositions, an anti-oxidizing agent (magnesium oxide or titanium oxide), an anti-ozonizing agent, a cross-linking agent or any combination thereof. In the fabrication process, the mixture can also be treated with various cross-linking processes, both chemical and radiation (e.g., gamma, UV, E-beam irradiation), to cross-link the polymer or co-polymers of the matrix.

In another embodiment, the insulating component can be hollow microspheres that carry any low thermal conductivity gas in the hollow. For example, a the microsphere core can carry an anti-oxidant gas (e.g., H₂) or a gas that serves as a foaming agent. Alternatively, the hollow core can be a partial vacuum.

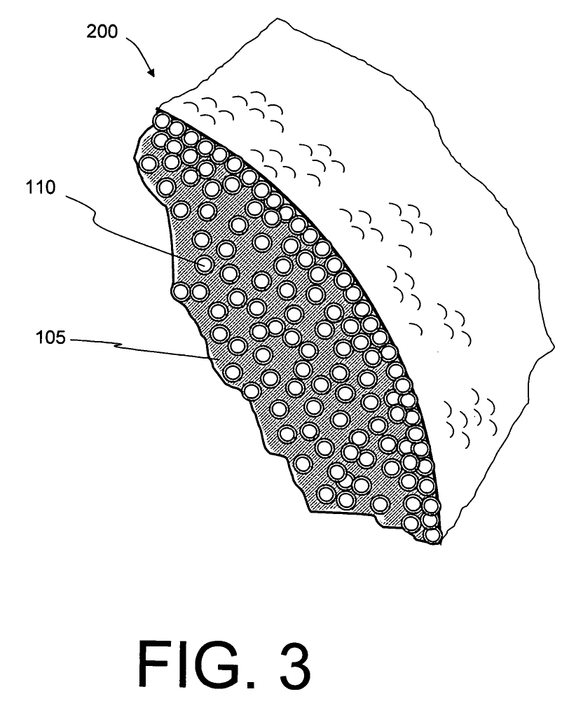

FIG. 3 illustrates another embodiment of a polymer 200 wherein the insulative particles 110 define a gradient in the material to provide a surface layer that exposes as close to 100% of insulator filler material as possible to provide a flame resistant surface. The scope of the invention includes any polymer article or coating that exposes a substantial percentage by volume of the insulator component at its surface.

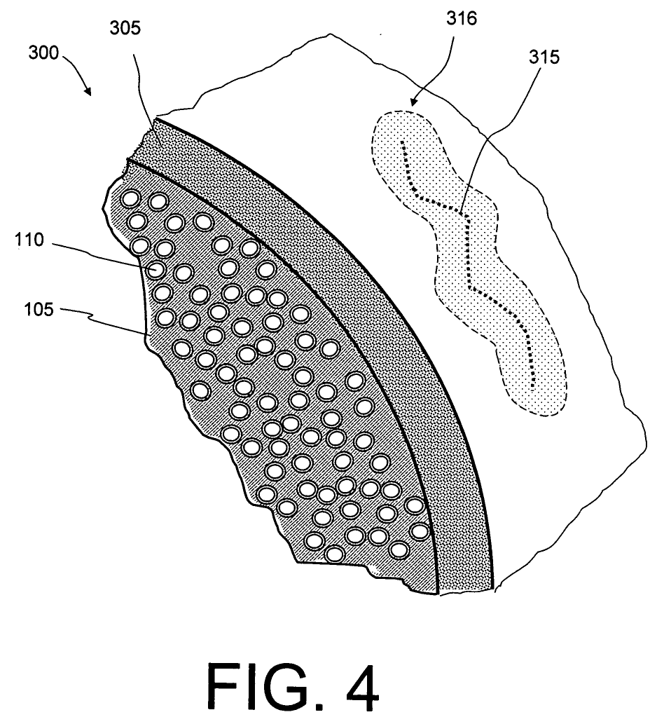

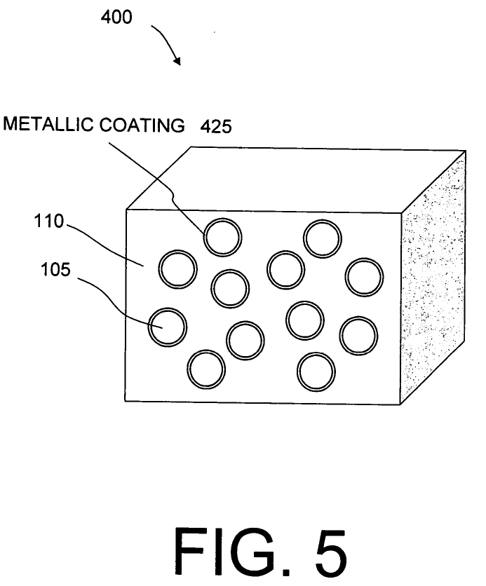

In another embodiment as depicted in FIG. 4, the polymer composition 300 carries a surface layer of a thermochromic material 305 that changes in color in response to thermal effects. A thermochromic polymer can be incorporated into the surface of the base polymer or be dispersed with the base polymer. Articles containing 0.1% to about 2.0% by weight of thermochromic pigments in the host polymer can be designed to have a visually observable, reversible thermochromic transition. Alternatively, a thermochromic paint or coating can be applied in various manners. Thermochromic materials are available from Chemsong, Inc., 923 Hawthorne Lane, West Chicago, Ill. 60185. In FIG. 5, it can be seen that a defect or crack 315 in the polymer then will cause a local region 316 of the object to exhibit a change in color. This can be useful for many applications for safety control and repair of defects in polymer insulator materials.

In another embodiment depicted in FIG. 5, the polymer composition 400 has a base polymer 105 with an insulative component or particles 110 of a different type. The particles again have the same insulator properties as described above. In this embodiment, the insulative particles have a thin metal coating or cladding 425, for example a nanometer thick layer of gold, silver, platinum or another suitable metallic material that can be deposited by electroless plating or other means. In one embodiment, the metal coating is of a ferromagnetic material that will thus respond to inductive heating from an electromagnetic source.

In another embodiment, the polymer composite can be used in any medical device, catheter or the like wherein the metallic coating provides radiopacity.

In another embodiment, the base polymer 105 has an insulative component comprising hollow particles as described above for use in medical instruments to provide a polymer that responds optimally to ultrasound imaging.

In another embodiment, the base polymer 105 can be a heat shrink type of polymer that can be used in tubing or tape to encase and insulate objects. Heat shrink polymers are well known in the art and need not be described further herein.

This specification describes various illustrative embodiments of a method and device of the present invention. The scope of the claims is intended to cover various modifications and equivalent arrangements of the illustrative embodiments disclosed in the specification. Therefore, the following claims should be accorded the reasonably broadest interpretation to cover modifications, equivalent structures, and features that are consistent with the spirit and scope of the invention disclosed herein.

1. A polymeric insulator composition, the composition comprising a first thermoplastic polymer component and a second filler component, wherein the filler component is dispersed within the polymer component and the filler component has a thermal conductivity of less than 5 W/m-° K.

2. A polymeric insulator composition as in claim 1 wherein the filler component has a thermal conductivity of less than 2 W/m-° K.

3. A polymeric insulator composition as in claim 1 wherein the filler component has a thermal conductivity of less than 0.5 W/m-° K.

4. A polymeric insulator composition as in claim 1 wherein the filler component is at least 10% by volume of the composition.

5. A polymeric insulator composition as in claim 1 wherein the filler component is at least 50% by volume of the composition.

6. A polymeric insulator composition as in claim 1 wherein the filler component is at least 80% by volume of the composition.

7. A polymeric insulator composition as in claim 1 wherein the polymer component is at least one of a polyethylene, a copolymer of at least one olefin, a polyamide, a polycarbonate, a polystyrene, a polyacrylonitrile, a polyethylene oxide, a polyacetal, a thermoplastic modified cellulose, a polysulfone, a thermoplastic polyester, a PET, a poly(ethylacrylate) or poly(methyl methacrylate), a nylon, a fluoropolymer such as polyvinylidene fluoride, or an ethylene tetrafluoroethylene.

8. A polymeric insulator composition as in claim 1 wherein the filler component comprises at least one of microspheres, particles, filaments and microtubes.

9. A polymeric insulator composition as in claim 1 wherein the filler component is at least one of a glass, a ceramic or a polymeric material.

10. A polymeric insulator composition as in claim 1 wherein the filler component is at least one of a solid material, a porous material and a hollow material.

11. A polymeric insulator composition as in claim 9 wherein the filler component has a metallic coating.

12. A polymeric insulator composition as in claim 8 wherein the filler component has a cross-sectional dimension across a principal axis of less that about 1000 microns.

13. A polymeric insulator composition as in claim 8 wherein the filler component has a cross-sectional dimension across a principal axis of less that about 100 microns.

14. A polymeric insulator composition as in claim 8 wherein the filler component has a cross-sectional dimension across a principal axis of less that about 500 nm.

15. A method of making a polymeric insulator composition comprising the steps of:
(a) providing a thermoplastic polymeric base material;
(b) providing a dispersable filler material that has a thermal conductivity of less than about 5 W/m-° K; and
(c) mixing the filler material in the polymeric base material.

16. A method as in claim 15 wherein the dispersing step includes mixing the filler material in the polymeric base material in an inert gas atmosphere for extending the mixing time and limiting oxidation reactions of the filler and polymeric base materials.

17. A method as in claim 15 wherein the mixing step includes mixing the filler material in the polymeric base material in a gas atmosphere free of oxygen.

18. A method as in claim 15 wherein the mixing step includes mixing the filler material in the polymeric base material in an inert gas atmosphere that is heavier than air.

19. A method as in claim 15 further comprising the step of applying cross-linking means to the polymeric base material comprising at least one of chemical cross-linking and cross-linking by irradiation.

20. A method as in claim 19 wherein the cross-linking by is at least on of gamma, UV and E-beam irradiation.

21. A method as in claim 15 further comprising the step dispersing anti-oxidation agents in the polymeric base material.

22. A method as in claim 15 wherein the filler material is selected from the class consisting of hollow materials, porous materials and solid materials.

23. A polymeric composition comprising a thermoplastic polymer with filler materials dispersed therein, the filler materials comprising hollow microspheres having a thermal conductivity of less than 5 W/m-° K.

24. A polymeric composition as in claim 23 wherein the microspheres have a mean cross-sectional dimension of less that about 500 microns.

25. A polymeric composition as in claim 23 wherein the microspheres have a mean cross-sectional dimension of less that about 100 microns.

26. A polymeric composition as in claim 23 wherein the filler materials are distributed in a gradient in the composition.

27. A polymeric composition as in claim 23 wherein the hollow microspheres are filled with a low thermal conductivity gas.

28. A polymeric composition as in claim 23 wherein the hollow microspheres are filled with a foaming agent.

29. A polymeric composition as in claim 23 wherein the hollow microspheres are filled with an anti-oxidant gas.

30. A polymeric composition as in claim 23 wherein the hollow microspheres have a partial vacuum therein.

31. A polymeric composition as in claim 23 wherein the hollow microspheres have a metallic coating.

32. A polymeric composition as in claim 23 wherein the hollow microspheres have a ferromagnetic coating.

33. A polymeric composition as in claim 23 further comprising thermochromic filler materials dispersed at least partly therein.

34. A polymer composition comprising a thermoplastic polymer with filler particles dispersed therein, the filler particles comprising first materials having a thermal conductivity of less than 5 W/m-° K. and second materials comprising thermochromic compositions.
